(19) United States
(12) Patent Application Publication
(10) Pub. No.: US 2009/0048778 A1
(43) Pub. Date: Feb. 19, 2009

(54) Process for Determining Vehicle Position

(75) Inventors: Neil L. Borkowicz, Plymouth, MI (US); Peter Herges, Stuttgart (DE); Joerg Huber, Durmersheim (DE); Roland Roessler, Leonberg (DE); Wilhelm Senske, Rodgau (DE); John A. Wilke, Oxford, MI (US); Axel Willikens, Waiblingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/839,022

(22) Filed: Aug. 15, 2007

(51) Int. Cl. G01C 21/36

(52) U.S. Cl. 701/213

(57) ABSTRACT

Method for finding a vehicle (2), wherein

a direction information item relating to the position of a mobile terminal (P2) with respect to the position (P1) of the vehicle is derived by comparing satellite supported position coordinates (P1, P2), and the respective direction information item is output by means of a display unit which is integrated into the mobile terminal (4),

the geographic position (P1) of the vehicle (2) is stored in the mobile terminal (4) in the form of position coordinates when the vehicle (2) is deactivated, wherein

if the mobile terminal (4) is in a second zone (Z2) surrounding a first zone (Z1), the current coordinates of the geographic position (P2) of the mobile terminal (4) are compared with the stored position (P1) of the vehicle, and

if the mobile terminal (4) is in the first zone (Z1), the coordinates of the position (P1) of the vehicle are interrogated from the vehicle on an updated basis by means of a satellite supported position determining system, and this position (P1) of the vehicle is compared with the current position (P2) of the device.

### BACKGROUND AND SUMMARY OF THE INVENTION

This invention relates to a method for determining a position of a vehicle.

German document DE 101 11 552 A1 discloses a mobile transponder for vehicles which has a visual display for the location of the vehicle with respect to the transponder. The mobile transponder contains a GPS receiver, determines its own current position, and compares its own determined current position with a known position of the vehicle. From this comparison, the transponder derives a direction information item and indicates, with the visual display, the direction in which the vehicle is located with respect to the position of the transponder. In addition, the transponder comprises a memory for GPS data in which the position of the vehicle is stored when the driver leaves the vehicle.

International application PCT/EP2007/003567, by the present applicant, discloses a device for finding a vehicle. The device comprises a portable unit with a pressure sensor having signals that can be evaluated by an evaluation and control unit in order to determine the current air pressure. The evaluation and control unit evaluates the identified air pressure here in order to determine the altitude, and the evaluation and control unit stores a first air pressure value as a reference pressure at a predefineable first time, which value represents an instantaneous altitude of a geographic position of the deactivated vehicle. The evaluation and control unit, at a second time and/or continuously, estimates a difference in altitude between the current geographic position of the portable unit and the geographic position of the deactivated vehicle on the basis of a pressure difference between the identified current air pressure value and the reference value.

An object of the invention is, therefore, the object of specifying an improved method for determining a position of a vehicle.

This object is achieved according to the invention by way of a method as claimed. Advantageous refinements of the invention are also claimed.

Accordingly, if the mobile terminal is in a second zone surrounding a first zone, the current coordinates of the geographic position of the mobile terminal are compared with the stored position of the vehicle.

If the mobile terminal is in the first zone, the coordinates of the position of the vehicle are interrogated from the vehicle on an updated basis by means of a satellite supported position determining system, and this position of the vehicle is compared with the current position of the device.

A Global Positioning System (GPS) is understood to refer to any satellite supported system/method for acquiring position coordinates. A GPS is based on satellites which continuously emit their changing position and the precise time. From their signal transit time GPS receivers can then calculate their own position and speed. Theoretically the signals from three satellites are sufficient for this. The satellites have to be located above their switch-off angle since the precise position and altitude can be determined from it. However, in practice GPS receivers do not have a clock which is accurate enough to be able to measure the transit times correctly. For this reason, the signal of a fourth satellite is required with which the precise time in the receiver is then also determined.

However, GPS position data is actually made available to consumers with a certain degree of inaccuracy. The absolutely accurate GPS position data is reserved for military purposes.

There are additional inaccuracies owing to the staggered timing of the interrogation of GPS position data.

According to the inventive method, in a first stage the vehicle position data is used in the second zone at the time when the vehicle is locked. In a second step, that is to say in the first zone—for example when there is radio contact with the vehicle—current GPS vehicle position data is continuously used with the continuously up-to-date GPS position data of the mobile terminal to identify the direction information.

The relative error between this coordinate data and the inaccuracy built in by the GPS position data provider can be minimized on the basis of the chronological correlation of the GPS position coordinates P1 and P2. This is possible since this data originates from the same satellites, the closer the position coordinates of the vehicle and that of the mobile terminal coincide.

By virtue of this two-stage method, a very accurate locating process to the position of the vehicle is possible since in the first zone the position coordinates have the same absolute error. However, this absolute error does not effect the result since, of course, a relative position—direction and distance—is to be specified. As a result, more accurate approximation to a target is possible than when conventional methods are used.

The range of the first zone is advantageously determined by the reception range of radio contact between the mobile terminal and the vehicle.

It proves advantageous that in the first zone the mobile terminal requests the current satellite supported position data from the vehicle by means of radio contact.

In a further improvement, the mobile terminal with all its functionalities is integrated into the vehicle's key.

When the vehicle is deactivated the position of the vehicle is advantageously identified by a GPS receiver in the vehicle and is transmitted to the mobile terminal or is identified by a GPS receiver in the mobile terminal.

In detail, the vehicle is equipped with a navigation device, in particular a GPS receiver.

In one advantageous embodiment, a mobile terminal is integrated into a vehicle key. In this mobile terminal, the geographic position of the vehicle can be stored and processed in the form of GPS data.

The mobile terminal also has an integrated compass for identifying a geographic direction.

Exemplary embodiments will be explained in more detail below with reference to the drawings.

### BRIEF DESCRIPTION OF THE DRAWINGS

FIG. 1 is a schematic block diagram illustrating an application of a method according to the invention for determining a position of a vehicle on a car park, and

FIG. 2 is a schematic block diagram similar to FIG. 1 for determining the position of a vehicle in a multistory car park.

### DETAILED DESCRIPTION OF THE INVENTION

Parts which correspond to one another are provided with the same reference symbols in all the figures.

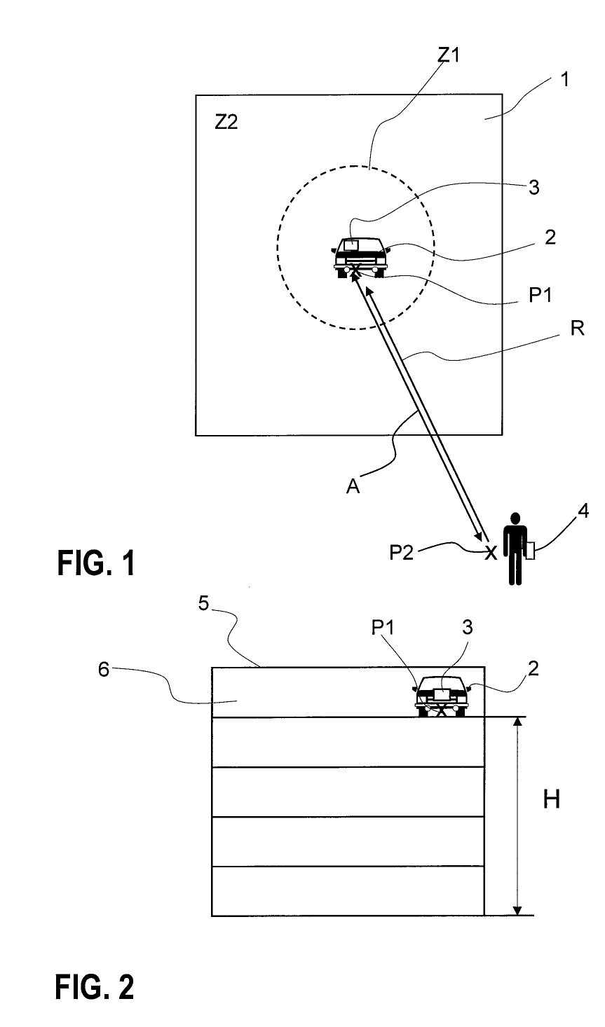

FIG. 1 shows by way of example the application of the method according to the invention for determining a position P1 of a vehicle on a car park 1.

The position P1 of the vehicle is preferably received in the form of position coordinates, that is to say GPS data, by means of a GPS receiver 3 which is installed in a vehicle 2, for example as part of a navigation device.

The mobile terminal 4 is part of a vehicle key. For this purpose, the vehicle key additionally has a GPS receiver. In addition, a memory for storing the position data, a computing unit for determining the direction information and a display unit for displaying the direction information are provided.

In the exemplary embodiment, the mobile terminal 4 is integrated into the vehicle key so that the various components such as computing unit, display unit, communications unit and memory are embodied as a unit with the vehicle key functions.

Alternatively, the mobile terminal 4 can also be embodied as an additional unit and, if appropriate, even be detachably integrated into the vehicle key.

The vehicle position P1 is preferably determined by the GPS receiver 3 in the vehicle 2 when the vehicle 2 is parked, and the position P1 of the vehicle is transmitted to the mobile terminal 4 which is integrated into the vehicle key.

Alternatively, the GPS receiver in the vehicle key identifies the position P1 of the vehicle when the vehicle 2 is locked, and the GPS receiver stores the vehicle position P1.

In order to determine the position of the vehicle 2 when it is found again after the vehicle has been deactivated, the surroundings of the vehicle 2 are divided into zones, in particular into a first zone Z1 (also referred to as short range zone) and a second zone Z2 (also referred to as longer range zone), in which case the second zone Z2 surrounds the first zone Z1.

The first zone or short range zone is determined by the reception radius of the radio communication between the vehicle key 4 and the vehicle and thus constitutes the short range zone with respect to the vehicle 2.

In order to find the vehicle 2, the mobile terminal 4 which is integrated into the vehicle key receives its device position P2 in the form of GPS position coordinates and compares them continuously with the stored coordinates P1 of the position of the vehicle as long as the mobile terminal 4 is in the second zone Z2.

The direction R of travel to the position P1 of the vehicle is presented by means of a display unit as direction information using a suitable display means, for example by means of directional arrows. This requires the mobile terminal 4 which is integrated into the vehicle key to additionally have a compass for determining a geographic direction. The representation of the direction should preferably also include the remaining distance A to the position P1 of the vehicle.

When the first zone Z1 is reached or when the mobile terminal 4 is located in the first zone Z1 in which radio contact is possible between the mobile terminal 4 and the permanently installed navigation device 3, the stored position P1 of the vehicle is not used to identify the direction. Instead, the position P1 of the vehicle is continuously interrogated from the vehicle 2 by means of radio contact, and is transmitted to the mobile terminal 4. For this purpose, the GPS receiver 3 in the vehicle 2 must continuously identify its GPS data at the respective time of interrogation by the mobile terminal 4 and transmit its data.

The direction information is then determined with the same method on the basis of the continuously up-to-date GPS position data P1 of the vehicle 2 and the continuously up-to-date GPS position data of the mobile terminal 4.

On the basis of the chronological correlation between the GPS position coordinates P1 and P2, the relative error between these coordinates can be minimized. This is possible since they originate from the same satellite, the closer the two position coordinates coincide.

Very precise routing to the position P1 of the vehicle is possible by means of this two-stage method since in the first zone the position coordinates have the same absolute error. However, this absolute error does not affect the result since, of course, a relative position—direction and distance—is to be specified.

The capture range of the antennas in the vehicle key and the vehicle determines the range of the first zone Z1 by means of a polling method. In this context, the vehicle key is correspondingly woken up by means of a signal and that signal is passed on to the integrated mobile terminal function unit. If the vehicle key is already in the first zone when the finding function is activated, the method is immediately used to find the vehicle 2 in the first zone Z1.

FIG. 2 shows by way of example the application of the method according to the invention to determine a position P1 of the vehicle according to FIG. 1 in a multistory car park 5.

If GPS position data can be received within the multistory car park and if there is radio contact with the vehicle 2, the method according to the invention can also be used to determine the story in which the vehicle is located from the first zone by virtue of the increased accuracy.

If there is no reception, the inventive method has to be extended. For this purpose, the data stored in the mobile terminal 4 contains the position P1 of the vehicle and an indication H of altitude above sea level. This requires both the vehicle and the mobile terminal 4 to be equipped with a suitable device for measuring altitude.

With this indication H of altitude it is possible to use the mobile terminal 4 to output the precise position P1 of the vehicle on the flat and additionally find the vehicle 2 on the correct floor of a multistory car park 5 by means of the indication H of altitude.

In one advantageous embodiment, the apparatus with integrated pressure sensors which is known from the applicant from International application PCT/EP2007/003567 can be used as an altitude measuring device. The apparatus determines a difference in altitude between the vehicle 2 and the mobile terminal 4 by means of a difference in air pressure.

1-5. (canceled)

6. A method for finding a vehicle, comprising:
deriving a direction information item relating to a current position of a mobile terminal with respect to a position of the vehicle by comparing satellite supported position coordinates, and outputting the direction information item by way of a display unit that is integrated into the mobile terminal,
storing the geographic position of the vehicle in the mobile terminal as position coordinates when the vehicle is deactivated,
comparing current coordinates of the position of the mobile terminal with the stored geographic position of the vehicle when the mobile terminal is in a second zone surrounding a first zone, and
interrogating the coordinates of the position of the vehicle from the vehicle on an updated basis by way of a satellite supported position determining system, and comparing this position of the vehicle with the current position of the device when the mobile terminal is in the first zone.

7. The method as claimed in claim 6, wherein a range of the first zone is determined by the reception range of radio contact between the mobile terminal and the vehicle.

8. The method as claimed in claim 6, wherein, in the first zone, the mobile terminal requests current satellite supported position data from the vehicle by way of radio contact.

9. The method as claimed in claim 6, wherein the mobile terminal is integrated into a vehicle key.

10. The method as claimed in claim 6, wherein, when the vehicle is deactivated, the position of the vehicle is identified by a GPS receiver in the vehicle, and is transmitted to the mobile terminal or identified by a GPS receiver in the mobile terminal.
